(19) United States
(12) Patent Application Publication
(10) Pub. No.: US 2006/0279708 A1
(43) Pub. Date: Dec. 14, 2006

(54) Electronic display apparatus having adaptable color gamut

(75) Inventors: Barry D. Silverstein, Rochester, NY (US); Thomas O. Maier, Rochester, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 11/150,996

(22) Filed: Jun. 13, 2005

(51) Int. Cl. G03B 21/14

(52) U.S. Cl. 353/84

(57) ABSTRACT

A method for adapting an electronic projection apparatus (10) to emulate the color gamut of a second display apparatus characterizes the color gamut (130) of the electronic projection apparatus (10) and the color gamut (130′) of the second display apparatus. At least one color filter (50) is placed in the electronic projection apparatus (10). The color filter (50) modifies the color gamut (130) of the electronic projection apparatus (10) and alters the spectral region for at least one primary color.

### FIELD OF THE INVENTION

This invention generally relates to an apparatus having an adaptable color gamut and more particularly relates to an electronic display apparatus.

### BACKGROUND OF THE INVENTION

In motion picture production, even though the bulk of image capture is done on film media, a considerable amount of editing and post-production work is carried out using digital image manipulation tools. During the digital intermediate process, a key process in preparing a motion picture production, images obtained during filming or generated digitally are displayed on a color monitor or electronic projector. Displaying the images in this manner creates a difficulty, since these display apparatuses have a significantly smaller color gamut than that of motion picture film. FIG. 1 shows a conventional chromaticity graph for color projection, familiar to those skilled in the color imaging arts. The outer “horseshoe” curve, termed a spectrum locus 100, represents pure colors, of a single wavelength, of the visible spectrum. A gamut 110 for motion picture print film is also represented in FIG. 1. The sizeable color gamut 110 of motion picture print film enables highly saturated colors to be projected and has been developed to provide visually pleasing display results.

The color gamut for a tricolor projection system is defined by its set of primary colors, located at their respective color coordinates within the chromaticity graph. These primary colors, typically Red, Green, and Blue (RGB) give vertices that define the generally triangular color gamut for the projection system. (Color print film used for motion pictures is a subtractive imaging system that is not properly characterized by three primary colors.)

With reference to FIG. 1, vertices 132, 134, and 136 define a color gamut 130 for an electronic projector. Vertices 142, 144, and 146 define a color gamut 140 for a CRT color monitor. The overall gamut for a device corresponds to the area of its triangular gamut 110, 130, or 140 as shown in FIG. 1. As is clearly shown, color gamut 110 for motion picture film exceeds color gamut 130 for an electronic projector and well exceeds color gamut 140 for a color monitor.

With a conventional CRT color monitor, vertices 142, 144, and 146 are defined by screen phosphors with which the CRT itself is manufactured. A conventional set of phosphors is used, as defined by specifications from SMPTE (the Society of Motion Picture and Television Engineers). Specific chromaticity coordinates that define vertices 142, 144, and 146 for CRT phosphors are given by SMPTE specification Rec. ITU-R BT.709-5. There is little that can be done to improve the color gamut of these devices for digital intermediate functions. As a work-around for this inherent problem, artists and technicians develop an intuitive grasp of the color differences they are dealing with and make adjustments in their color work accordingly. With this conventional arrangement, there is a risk of lower color quality from the digital intermediate process.

With electronic projectors, however, the color gamut available may not be as rigidly fixed. There would be considerable benefits to methods for adapting the color gamut of an electronic projector to suit digital intermediate production work, including methods that change a color gamut from one range to another to emulate different film types of projection apparatus.

### SUMMARY OF THE INVENTION

The aforementioned need is addressed according to the present invention by providing a method for adapting an electronic projection apparatus to emulate the color gamut of a second display apparatus including:

a) characterizing the color gamut of the electronic projection apparatus;

b) characterizing the color gamut of the second display apparatus;

c) inputting at least one color filter in the electronic projection apparatus;

d) modifying the color gamut of the electronic projection apparatus with the color filter to alter the spectral region for at least one primary color.

Another aspect of the present invention provides an electronic projection apparatus that includes an interchangeable color filter for providing light to a spatial light modulator. The color filter includes encoding that identifies characteristics of the color filter. In addition the present invention includes a sensor for sensing the encoding, and a control logic processor for controlling behavior of the spatial light modulator according to the encoding.

It is a feature of the present invention that it employs color filters to adjust the color gamut of an existing electronic projection apparatus.

It is an advantage of the present invention that it allows an electronic projection apparatus to more closely emulate the color performance of another type or other types of display apparatuses.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings, wherein:

FIG. 1 is a chromaticity graph comparing color gamuts for CRT, conventional electronic projection apparatus, and color print film;

FIG. 2 is a schematic diagram showing a prior art electronic projection apparatus;

FIG. 3A is a graph showing transmission characteristics for a prior art electronic projection apparatus;

FIG. 3B is a graph showing idealized transmission characteristics for a maximized color gamut;

FIG. 3C is a graph showing the modified transmission characteristics needed for improved emulation according to the present invention;

FIG. 4 is a chromaticity graph comparing color gamuts for CRT, electronic projection apparatus adapted according to the present invention, and color print film;

FIG. 5 is a schematic diagram of an alternative embodiment of a digital projection apparatus;

FIG. 6 is a schematic diagram of another alternate embodiment of an electronic projection apparatus according to the present invention;

FIG. 7 is a graph showing the slight spectral shift at different incident angles for one set of filter coatings; and,

FIGS. 8A and 8B are cross-sectional diagrams showing the use of a filter package inserted into a projector in one embodiment.

### DETAILED DESCRIPTION OF THE INVENTION

The present description is directed in particular to elements forming part of, or cooperating more directly with, apparatus in accordance with the invention. It is to be understood that elements not specifically shown or described may take various forms well known to those skilled in the art.

The most promising solutions for multicolor digital cinema projection employ, as image forming devices, one of two basic types of spatial light modulators. The first type of spatial light modulator is the Digital Micromirror Device (DMD), developed for Digital Light Processing (DLP) systems by Texas Instruments, Inc., Dallas, Tex. DMD devices are described in a number of patents, for example U.S. Pat. No. 4,441,791; No. 5,535,047; No. 5,600,383 (all to Hornbeck); and U.S. Pat. No. 5,719,695 (Heimbuch). Optical designs for projection apparatus employing DMDs are disclosed in U.S. Pat. No. 5,914,818 (Tejada et al.); U.S. Pat. No. 5,930,050 (Dewald); U.S. Pat. No. 6,008,951 (Anderson); and U.S. Pat. No. 6,089,717 (Iwai). DMDs have been employed in electronic projection systems. However, although DMD-based projectors demonstrate some capability to provide the necessary light throughput, contrast ratio, and color gamut, inherent resolution limitations (with current devices providing only 2048×1096 pixels) and high component and system costs have restricted DMD acceptability for high-quality digital cinema projection.

The second type of spatial light modulator used for digital projection is the LCD (Liquid Crystal Device). The LCD forms an image as an array of pixels by selectively modulating the polarization state of incident light for each corresponding pixel. LCDs appear to have advantages as spatial light modulators for high-quality digital cinema projection systems. These advantages include relatively large device size and favorable device yields. Among examples of electronic projection apparatus that utilize LCD spatial light modulators are those disclosed in U.S. Pat. No. 5,808,795 (Shimomura et al.); U.S. Pat. No. 5,798,819 (Hattori et al.); U.S. Pat. No. 5,918,961 (Ueda); U.S. Pat. No. 6,010,121 (Maki et al.); and U.S. Pat. No. 6,062,694 (Oikawa et al.).

In an electronic projection apparatus using spatial light modulators, individual colors, conventionally Red, Green, and Blue, are separately modulated in a corresponding red, green, or blue portion of the optical path. The modulated light of each color is then combined in order to form a composite, multicolor RGB color image.

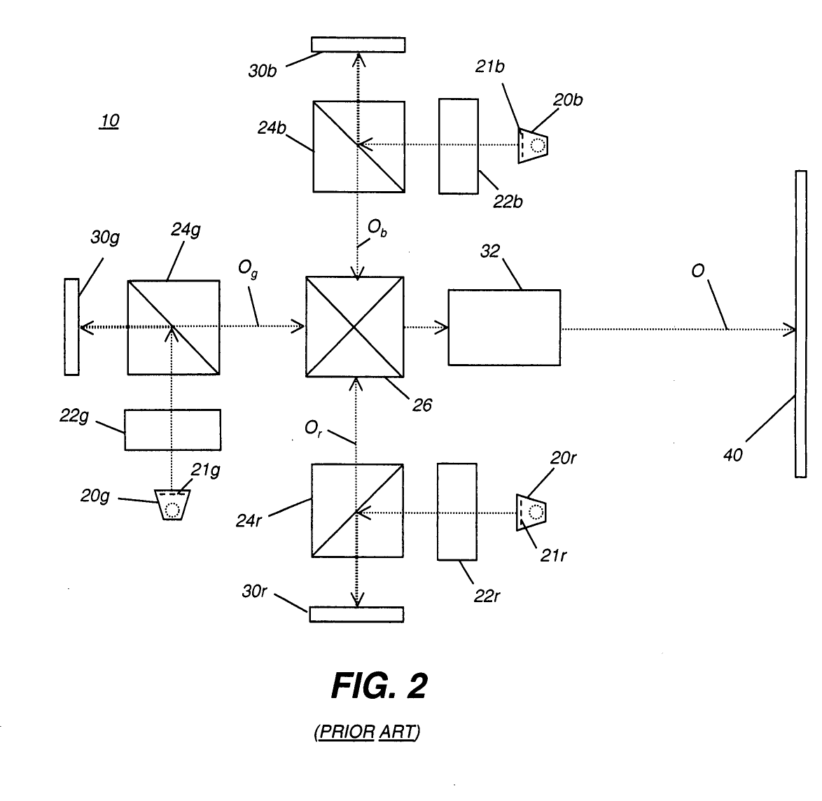

Referring to FIG. 2, there is shown a simplified block diagram of a conventional electronic projection apparatus 10 in one embodiment. Each color path (r=Red, g=Green, b=Blue) uses similar components for forming a modulated light beam. Individual components within each path are labeled with an appended r, g, or b, appropriately. Following any of the three color paths, a light source 20r, 20g, or 20b provides unmodulated light through a corresponding color filter 21r, 21g, or 21b. The unmodulated, filtered light is conditioned by uniformizing optics 22r, 22g, or 22b to provide a uniform illumination. A polarizing beamsplitter 24r, 24g, or 24b directs light having the appropriate polarization state to a spatial light modulator 30r, 30g, or 30b which selectively modulates the polarization state of the incident light over an array of pixel sites. The action of spatial light modulator 30r, 30g, 30b forms an image. The modulated light from this image, transmitted along an optical axis Oᵣ/O_{g}/O_{b} through polarizing beamsplitter 24r, 24g, 24b, is directed to a dichroic combiner 26, typically an X-cube, Philips prism, or combination of dichroic surfaces in conventional systems. Dichroic combiner 26 combines the red, green, and blue modulated images from separate optical axes Oᵣ/O_{g}/O_{b} to form a combined, multicolor image for a projection lens 32 along a common optical axis O for projection onto a display surface 40, such as a projection screen.

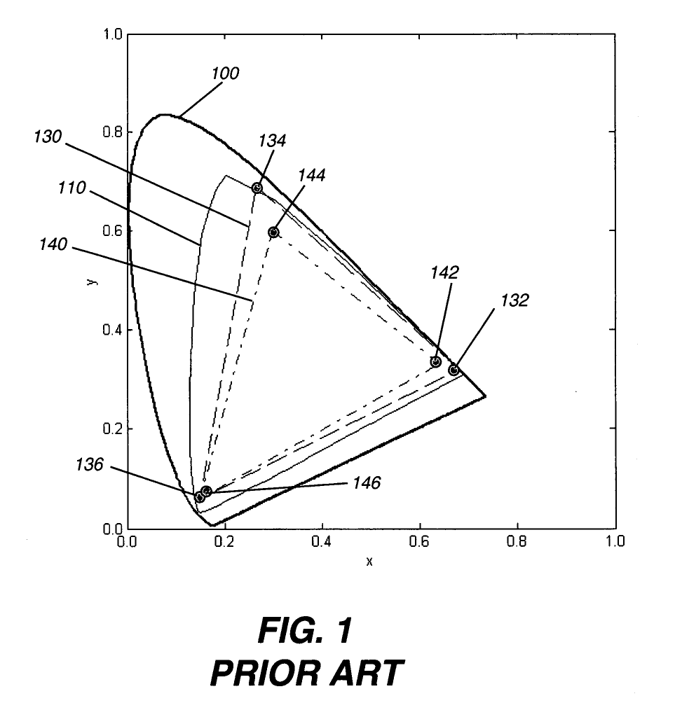

In general, electronic projection apparatus 10 employ Xenon lighting with appropriate filters to provide primary colors at light sources 20r, 20g, and 20b. These primary colors provide Red, Green, and Blue vertices 132, 134, and 136 of color gamut 130 in FIG. 1, as described in the background section above. SMPTE specification Rec. ITU-R BT.709-5, noted above with respect to CRT phosphors, also lists target chromaticity coordinates for electronic projection systems 10. These chromaticity coordinates define Red, Green, and Blue vertices 132, 134, and 136 of color gamut 130 in FIG. 1.

A goal of the present invention is to emulate the color range of motion picture print film using electronic projection apparatus 10. If this can be achieved, electronic projection apparatus 10 can be adapted to better suit the needs of the digital intermediate environment.

As a general principle, improved spectral purity of primary colors is needed in order to expand the color gamut for a tricolor projection device. With respect to FIG. 1, improved spectral purity, obtained by narrowing the spectral range of each color primary, would move Red, Green, and Blue vertices 132, 134, and 136 closer to spectrum locus 100. Of course, narrowing the spectral range of color primaries would necessarily reduce the overall amount of light. By design, electronic projection apparatus 10 is intended to project images for an audience onto a large display screen. This demands a considerable amount of light. Thus, in projector design, some compromise is made between achieving a reasonably large color gamut 130 and maximizing brightness.

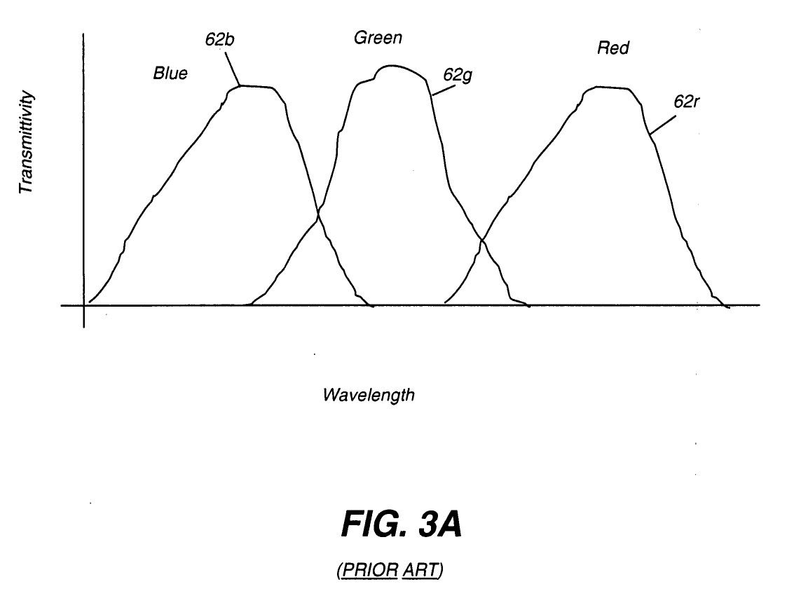

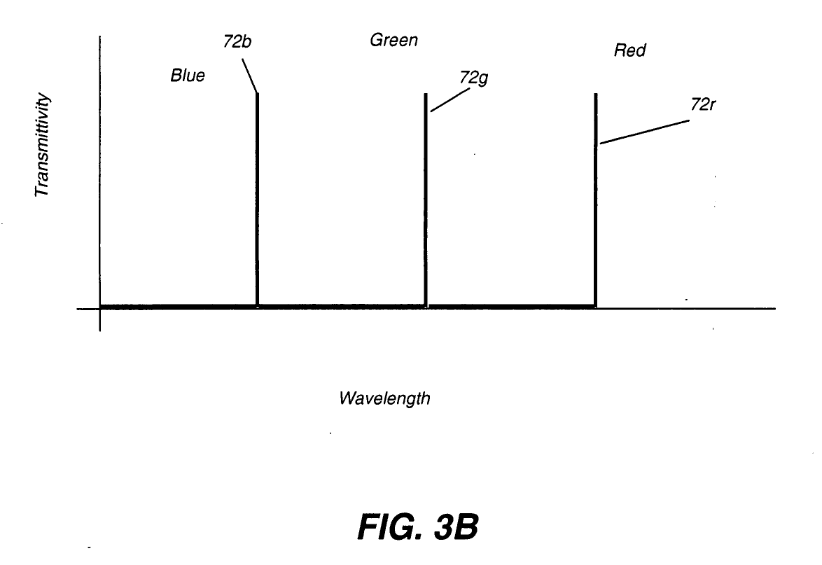

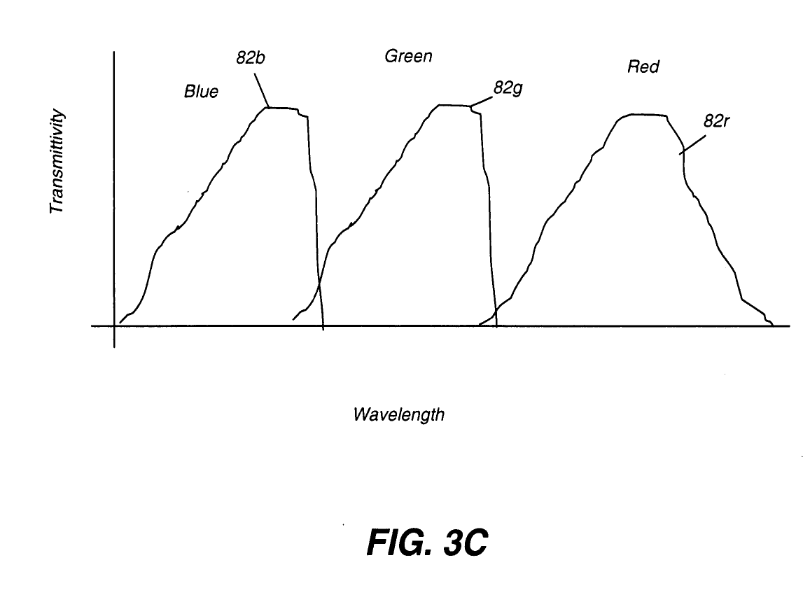

FIG. 3A shows the approximate spectral range of color filters used in a conventional embodiment of electronic projection apparatus 10, with relative transmission plotted against wavelength. Filter transmission curves 62r, 62g, and 62b each overlap each other and transmit light over a relative broad range of wavelengths. By comparison, FIG. 3B shows the spectral range for an idealized set of color filters. Here, the spectral range of each color filter is very narrow, as shown in exaggerated form by filter transmission curves 72r, 72g, and 72b. While the ideal values represented in FIG. 3B may not be reasonably achieved today in practice, significant improvement can be obtained by using filters that truncate the upper portion of the range for blue and green color filters 21b and 21g. FIG. 3C shows this truncation between blue and green and between green and red in an example embodiment. Here filter transmission curves 82b and 82g are made narrower to provide the needed truncation, primarily by providing a sharper cutoff at high frequencies.

Filter characteristics for color filters 21r, 21g, and 21b in one exemplary embodiment are listed in the following table.

| Primary color | Min. wavelength | Max. wavelength | Efficiency |
|---|---|---|---|
| Red | 600 nm | 780 nm | 17 |
| Green | 514 nm | 538 nm | 19 |
| Blue | 400 nm | 490 nm | 5 |

Because the digital intermediate process is used for color viewing and content manipulation by an artist or technician, for example in a screening room environment, the need for increased brightness is reduced. Thus, some amount of brightness can be sacrificed with the goal of obtaining a larger color gamut.

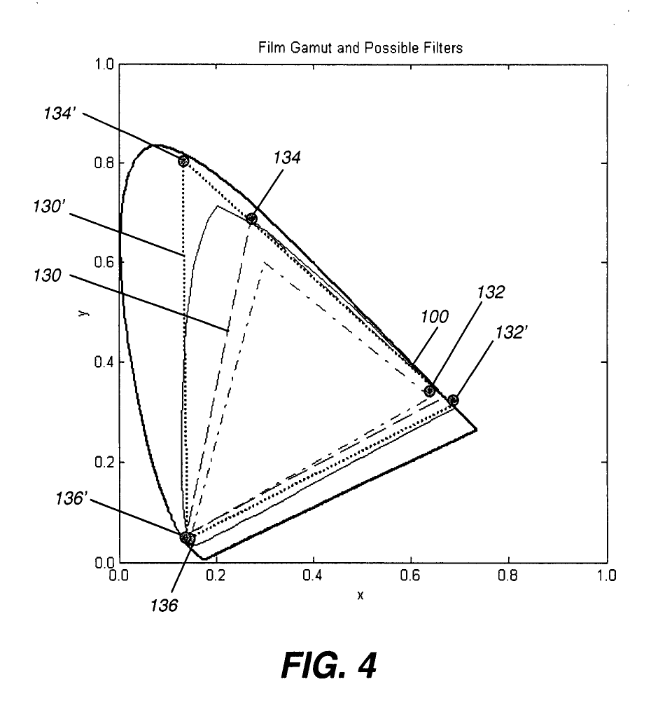

FIG. 4 shows an enlarged color gamut 130′ obtained by narrowing the spectral transmission of color filters used in each color channel of electronic projection apparatus 10 by truncation of the filter pass band. Notably, the spectral range of green color filter 21g, corresponding to vertex 134′ yields a significant improvement in color gamut. Other vertices 132′ and 136′ for red and blue provide slight improvement by comparison.

By way of illustration, the following table lists chromaticity coordinates for conventional color gamut 130 and improved color gamut 130′ of FIG. 4 in one exemplary embodiment.

| Primary | Conventional x | Conventional y | Improved x | Improved y |
|---|---|---|---|---|
| color | value | value | value | value |
| Red | 0.68 | 0.32 | 0.6851 | 0.3148 |
| Green | 0.30 | 0.60 | 0.1323 | 0.8063 |
| Blue | 0.15 | 0.06 | 0.1412 | 0.0456 |

Guidelines for Filter Selection

In one embodiment, the present invention adapts electronic projection apparatus 10 to the color gamut of a motion picture print film. In practice, there are many sets of alternative primaries that can be used in electronic projection apparatus 10, depending on the particular characteristics of a print film.

As a general guideline, the primary colors that provide vertices for enlarged color gamut 130′ should be outside of the corresponding vertices of conventional color gamut 130. This is illustrated in the preceding table for one exemplary embodiment. As a threshold value, the area of the improved gamut 130′ triangle formed by the three primaries of this invention should be at least 1.05 times the area formed by the primaries in conventional color gamut 130. For example, the area of the triangle of gamut 130 formed by the primaries in the preceding table is 0.1520. Therefore, the area of the triangle of improved gamut 130′ formed by the primaries of this invention should be at least 0.1596. As FIG. 4 shows, most of the gain in gamut is likely to result from green vertex 134′.

Positioning of Color Filters 21r, 21g, and 21b

The deployment of color filters 21r, 21g, and 21b within electronic projection apparatus 10 depends on the overall architecture of this system. For the embodiment of electronic projection apparatus 10 shown in FIG. 2, each of color filters 21r, 21g, and 21b is disposed proximate to its corresponding light source.

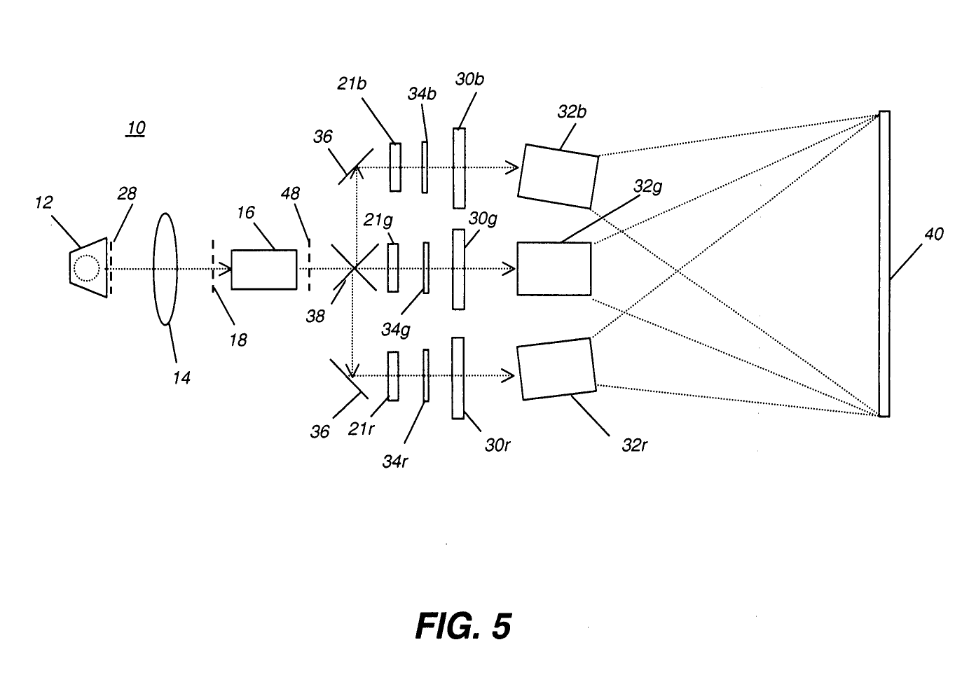

Referring to FIG. 5, an alternative embodiment of electronic projection apparatus 10 is shown. In this alternative embodiment, a light source 12 directs light through a lens 14 and a uniformizer 16. A dichroic separator 38, represented in FIG. 5 as a set of crossed dichroic surfaces, splits the white light from light source 12 into its primary Red, Green, and Blue components. The color light is then directed along each color channel, through a color filter 21r, 21g, or 21b and through a polarizer 34r, 34g, or 34b to its respective spatial light modulator 30r, 30g, or 30b. Mirrors 36 are provided to redirect illumination in the red and blue color channels. In the particular embodiment of FIG. 5, spatial light modulator 30r, 30g, or 30b is shown as a transmissive device; an alternative configuration, familiar to those skilled in the color imaging arts, would allow the use of a reflective spatial light modulator 30r, 30g, or 30b. Separate red, green, and blue projection lenses 32r, 32g, and 32b would be used to direct and overlay the modulated light of different colors onto display surface 40. For the embodiment of FIG. 5, notch filters or bandpass limiting filters can be placed at positions 18, 38, or 48. Position 18 is particularly advantageous, filtering the illumination before uniformization takes place. In this case, the spectral limiting filter can be a single removable element, providing minimal complexity and greater flexibility for the system.

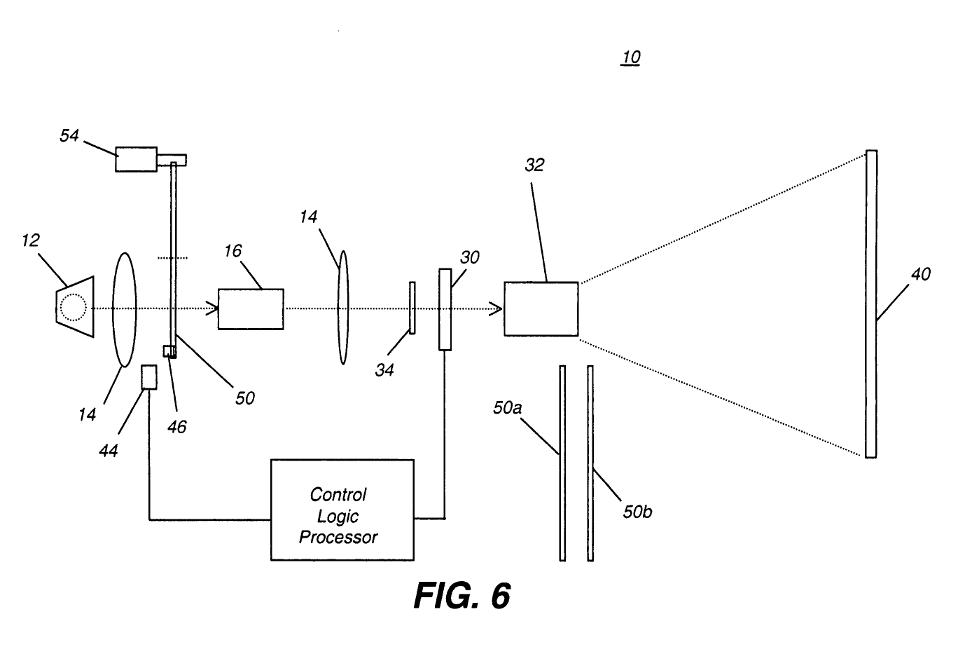

Referring to FIG. 6, another alternative embodiment of electronic projection apparatus 10 is shown. Here, a single spatial light modulator 30 is provided for successively modulating light in each of the three or more color channels. A color wheel 50, rotated by a motor 54, provides the needed color filter to provide, in sequence, light of each primary color. A polarizer 34 polarizes the light that is directed to spatial light modulator 30. Projection lens 32 then directs the modulated light to display surface 40. In this embodiment, the desired filtering is performed by separate filter elements within color wheel 50.

Filters 21r, 21g, and 21b can be positioned at any suitable place along the color channel. For example, it may be most suitable to place one or more of filters 21r, 21g, or 21b near its corresponding spatial light modulator 30r, 30g, or 30b.

Other Key Characteristics of Filters 21r, 21g, and 21b

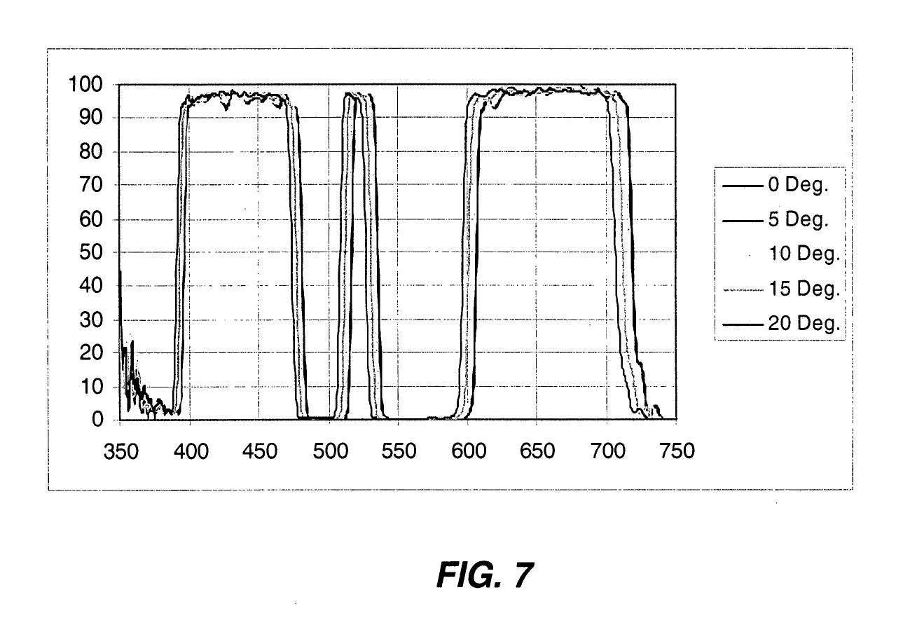

In addition to the spectral requirements outlined above, other requirements on color filters 21r, 21g, and 21b may include the following:
i) Temperature resilience. Because of the generally high power levels needed for digital projection, color filters 21r, 21g, and 21b are fabricated from fused silica in one embodiment. In general, it is preferred that heat absorption be minimal, since filter coatings would be adversely impacted.
ii) Angularly insensitivity. Filter coatings should preferably be angularly insensitive, performing suitably, and with minimal spectral shift, with incident light over a wide range of angles. Nominal incident angle is typically within a ±20 degree cone angle. The graph of FIG. 7 shows the effect of different incident light angles on a set of color filters in one embodiment.
iii) High transmission. It is desirable for the color filter(s) to have high transmission so as not to further reduce the desired output light of the remaining spectrum.
iv) Steep Slope Angles. Because the gamut and transmission is defined by the remaining light, maximum transmission and rejection occur when the slope characteristics of the fabricated filter are very sharp. Sharp slope characteristics can be defined as exhibiting a transition from 10 to 90% transmission within 5 nm wavelength.

Filters 21r, 21g, and 21b can be fabricated from traditional thin film dielectric stacks with traditional materials or using less traditional index varying means such as a rugate filter that provides a sinusoidally varying response. A rugate filter uses an interference coating with a variable refractive index. Rugate filters are available from Barr Associates, Inc., Westford, Mass. Separate color filters 21r, 21g, and 21b could be coated on each side of a filter substrate. The filter substrate could be fused silica, standard BK7 glass or an LCD substrate glass such as Corning 1737F. In an alternate embodiment, the filter can be fabricated using traditional thin film dielectric stacks formulated for the entire visible spectrum. This could be done with a single thin film coating with notches between blue/green and green/red spectral bands. Similarly, in one embodiment, the entire spectrum could be handled on a single substrate with coatings on each side of the substrate, where one coating handles the rejection between blue and green, while the other coating handles the rejection between green and red.

Filters 21r, 21g, and 21b should be easily replaceable to facilitate cleaning and replacement and to enable the use of different sets of filters within electronic projection apparatus 10. In this way, electronic projection apparatus 10 can be provided with a set of filters 21r, 21g, and 21b that enable it to emulate the color gamut of other media, such as conventional print film, or of other display devices. Referring to FIG. 6, for example, color filter wheel 50 is a replaceable item, provided for color emulation of a particular motion picture print film type. When color filter wheel 50 is installed in projection apparatus 10, a sensor 44 reads an encoding 46 coupled to color filter wheel 50. Encoding 46 contains some level of information about color filter characteristics of color filter wheel 50. Based on information from encoding 46, a control logic processor 42, in communication with sensor 44, provides control signals for adjusting modulation by spatial light modulator 30, in order to suitably condition the response of spatial light modulator 30 for filter characteristics. This control may be exercised, for example, by using a special set of Look-Up Tables (LUTs) that condition image data values suitably for the specific characteristics of color filter wheel 50. In one embodiment, LUT data values or other parameters are stored directly in encoding 46, such as using bar code or a wireless memory device, for example. Alternately, encoding 46 may provide an address to current LUT data that is available online, such as a network address or Universal Resource Locator, for example. As yet another option, an operator may enter information identifying color filter wheel 50 on a keypad or other interface device.

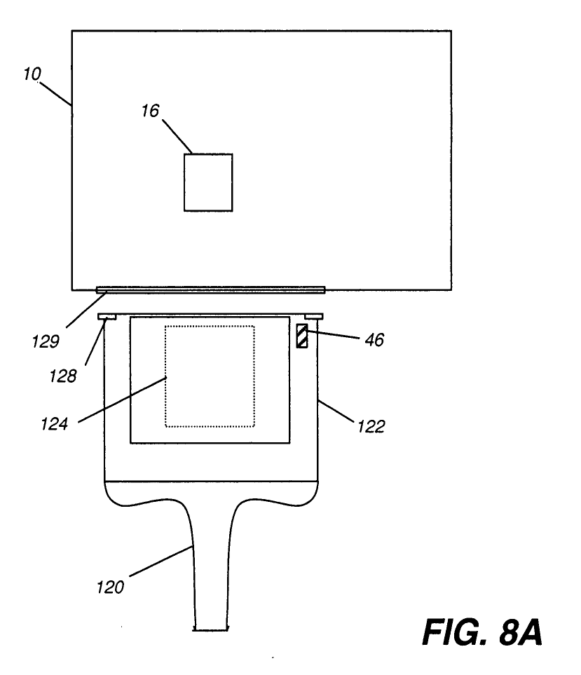

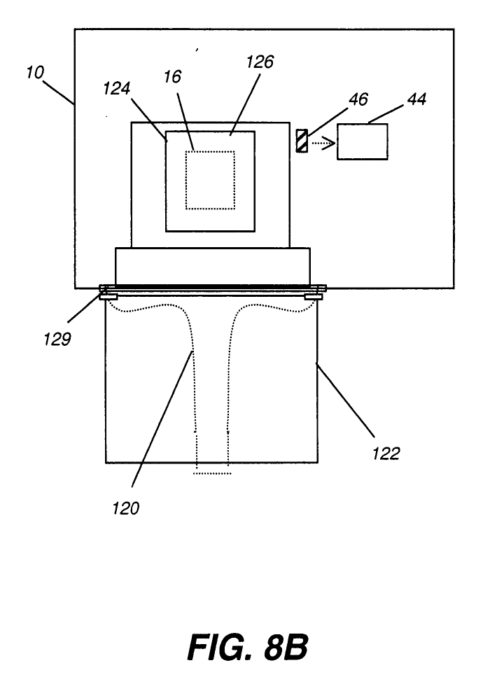

In yet another alternative embodiment, as shown in FIGS. 8A and 8B, one or more filter units 120 can be inserted into projection apparatus 10. Filter unit 120 provides a protective housing 122 that includes a filter 124 (shown in outline in FIG. 8A) or some combination of filters 124. In the view shown in FIGS. 8A and 8B, the optical axis of projection apparatus 10 is normal to the page. Uniformizer 16 is an integrator bar, shown in cross-section. Encoding 46 is read by sensor 44 to determine characteristics of filter 124 or to obtain LUTs or other color data. Once filter unit 120 is placed inside projector 10 in the illumination path, an aperture 126 opens, either mechanically or electrically actuated, to allow light to pass through. Filter unit 120 may employ mechanical tabs 128 that cause aperture 126 to be opened when filter unit 120 is inserted into a slot 129. Alternately, filter unit 120 could provide a color wheel, such that different filters may be rotated in place to select different color gamuts for particular situations. This filter wheel could be operated manually or by control of electronics and software running within projection apparatus 10.

Process for Display Emulation

Using the present invention, the procedure for adapting electronic projection apparatus 10 to emulate a particular film or, more generally, another type of display apparatus as a “target” display would use the following steps:
a) Characterize the color gamut of the target display. This operation is familiar to those skilled in the color imaging arts and involves obtaining the information needed to map out the color gamut of the target display as is shown in FIGS. 1 and 4.
b) Characterize color gamut 130 of projection apparatus 10. This provides a starting point for expanding one or more vertices 132, 134, 136 that define color gamut 130. Color gamut 130 is obtained by identifying the chromaticity coordinates of the color primaries for this device.
c) Place one or more color filters in the path of unmodulated light in order to constrain the spectral range of the corresponding projection apparatus color primary or primaries.

While this method may somewhat reduce the light output of a conventional projection apparatus 10, the advantage is better emulation of a motion picture print film or other display apparatus. In the digital intermediate environment, this may require an operator to project over a smaller display surface 40; however, this would not be a disadvantage for the work performed in that environment.

The present invention allows projection apparatus 10 to be adaptable to any one of a number of different color gamuts, thereby enabling different sets of color filters to be provided for projection apparatus 10, each set designed to provide a specific “color personality” to the imaging device. For example, as is shown in FIG. 6, electronic projection apparatus 10 could be provided with multiple color wheels 50, 50a, and 50b. Each color wheel 50, 50a, and 50b modifies the output color gamut of the device to emulate a specific projector type, film type, or other imaging mechanism. Selecting and disposing a specific interchangeable color wheel 50, 50a, or 50b could be performed manually by the operator or could be performed in an automated fashion, wherein the appropriate color wheel 50, 50a, or 50b is switched into place as needed.

Thus, what is provided is an apparatus and method for varying the color gamut of an electronic projection apparatus to emulate the color gamut of a different type of projector or imaging medium or device.

The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention. For example, the color filters of the present invention can be of various types, placed at various positions within the electronic projector. One or more color filters can be used. Color filters can also be designed to cooperate with corresponding dichroic surfaces that selectively reflect and transmit light according to wavelength.

### PARTS LIST

10 Projection apparatus
12 Light source
14 Lens
16 Uniformizer
18 Position
20, 20r, 20g, 20b Light source; Light source, red; Light source, green; Light source, blue
22r, 22g, 22b Uniformizing optics, red; Uniformizing optics, green; Uniformizing optics, blue
24r, 24g, 24b Polarizing beamsplitter, red; Polarizing beamsplitter, green; Polarizing beamsplitter, blue
26 Dichroic combiner
28 Position
30, 30r, 30g, 30b Spatial light modulator; Spatial light modulator, red; Spatial light modulator, green; Spatial light modulator, blue
32, 32r, 32g, 32b. Projection lens; Projection lens, red; Projection lens, green; Projection lens, blue
34, 34r, 34g, 34b Polarizer; Polarizer, red; Polarizer, green; Polarizer, blue
36 Mirror
38 Dichroic separator
40 Display surface
42 Control logic processor
44 Sensor
46 Encoding
48 Position
50, 50a, 50b Color filter wheel
54 Motor
62r, 62g, 62b Transmission curve
72r, 72g, 72b Transmission curve
100 Spectrum locus
110 Gamut
120 Filter unit
122 Housing
124 Filter
126 Aperture
128 Tab
129 Slot
130, 130′ Gamut
132, 134, 136 Vertex
132′, 134′, 136′ Vertex
140 Gamut
142, 144, 146 Vertex
O, Oᵣ, O_{g}, O_{b} Optical axis; Optical axis, red; Optical axis, green; Optical axis, blue

What is claimed is:

1. A method for adapting an electronic projection apparatus to emulate the color gamut of a second display apparatus comprising the steps of:
a) characterizing the color gamut of the electronic projection apparatus;
b) characterizing the color gamut of the second display apparatus;
c) inputting at least one color filter in the electronic projection apparatus; and
d) modifying the color gamut of the electronic projection apparatus with the color filter to alter the spectral region for at least one primary color.

2. The method according to claim 1 wherein at least one color filter in the electronic projection apparatus is a color wheel.

3. The method according to claim 1 where in the at least one color filter in the electronic projection apparatus resides in a removable filter housing.

4. The method according to claim 1 wherein the color filter is comprised of thin film dielectric layers.

5. The method according to claim 4 wherein the color filter is a rugate filter.

6. The method according to claim 1 wherein the area of the modified color gamut of the electronic projection apparatus is at least 1.05 times the area of the original color gamut of the electronic projection apparatus.

7. The method according to claim 1 further comprising the step of reading an encoding coupled to the at least one color filter to obtain information related to the filter.

8. The method according to claim 7 wherein the encoding is stored in a memory of a wireless communication device.

9. The method according to claim 7 wherein the encoding is a bar code.

10. The method according to claim 7 wherein the encoding stores a network address.

11. The method according to claim 10 further comprising the step of initiating a network connection with the electronic projection apparatus to obtain information about the at least one color filter.

12. The method according to claim 1 wherein the color filter truncates a portion of visible spectrum between blue and green wavelengths.

13. The method according to claim 1 wherein the color filter truncates a portion of visible spectrum between green and red wavelengths.

14. The method according to claim 1 wherein the color filter is a thin film dielectric stack.

15. An electronic projection apparatus comprising:
a) an interchangeable color filter for providing light to a spatial light modulator, wherein the color filter comprises an encoding identifying characteristics of the color filter;
b) a sensor for sensing the encoding; and
c) a control logic processor for controlling behavior of the spatial light modulator according to the encoding.

16. The electronic projection apparatus according to claim 15 wherein the encoding is a bar code.

17. The electronic projection apparatus according to claim 15 wherein the encoding is accessed by a wireless communication device.

18. The electronic projection apparatus according to claim 15 wherein the color filter is provided on a color filter wheel.

19. The electronic projection apparatus according to claim 15 wherein the interchangeable color filter is a rugate filter.

20. The electronic projection apparatus according to claim 15 wherein the interchangeable color filter is a thin film dielectric stack.

21. The electronic projection apparatus according to claim 18 wherein a repeating sequence of colors are sent to the spatial light modulator.

22. The electronic projection apparatus according to claim 15 wherein the characteristics of the color filter include spectral transmission of the color filter.

23. A replaceable color filter unit for an electronic projection apparatus comprising a color filter within a protective housing, whereby the color filter is disposed in the optical path of the electronic projection apparatus when the color filter unit is inserted into the electronic projection apparatus.

24. The replaceable color filter unit according to claim 23 further comprising an encoding that is read by a sensor within the electronic projection apparatus, in order to condition the behavior of a spatial light modulator.

25. The replaceable color filter unit according to claim 23 wherein the color filter is a rugate filter.

26. The replaceable color filter unit according to claim 23 wherein the color filter is a color filter wheel.

27. The replaceable color filter unit according to claim 23 wherein the color filter is a thin film dielectric stack.
